(19) United States
(12) Patent Application Publication
(10) Pub. No.: US 2006/0206301 A1
(43) Pub. Date: Sep. 14, 2006

(54) Determining the reading of a kanji word

(76) Inventor: Wei-Bin Chang, Miaoli (TW)

Correspondence Address: PHILIPS INTELLECTUAL PROPERTY & STANDARDS, P.O. BOX 3001, BRIARCLIFF MANOR, NY, 10510, US

(21) Appl. No.: 10/522,468

(22) PCT Filed: Jul. 28, 2003
(86) PCT No.: PCT/IB03/02987

§ 371 Date: Sep. 2, 2005

(30) Foreign Application Priority Data
Jul. 31, 2002 (DE) 020 17 174.0

(51) Int. Cl. G06F 17/20

(52) U.S. Cl. 704/1

(57) ABSTRACT

A method of automatically determining a reading of a Japanese word includes for each character determining whether the character is a kanji, hiragana 520, or katakana 530 character. For a hiragana or katakana character the only one reading associated with the character is chosen in step 525, 535. For a kanji character it is determined in step 540 whether or not the immediately preceding character and/or the immediately succeeding character is also a kanji character. If so, for the kanji character an on-reading associated with the kanji character is chosen in step 550. If not, a kun-reading associated with the kanji character is chosen in step 560.

The invention relates to a method of automatically converting a Japanese word from a textual form to a corresponding reading of the word.

For several speech applications it is required to have access to a reading of words. With reading is meant a phonetic way of pronouncing the word. As an example, to be able to automatically recognize one or more words spoken by a person, a speech recognizer typically includes a lexicon wherein a way of pronouncing the word (the “reading”) is converted to a “textual” form. For dictation applications, the textual form is usually displayed on a screen and stored in a word processor. For voice control, the textual form may simply be an internal command that controls the device. It may not be required to actually store or display an exact textual representation. Similarly, for the reading any suitable form of representing a way of pronouncing a word may be used, including a phonetic alphabet, di-phones, etc. Typically, building a lexicon relied heavily on manual input of linguists. In particular for large-vocabulary continuous speech recognition systems a conventional lexicon is not large enough to cover all words actually used by users. In such systems, it is desired to be able to automatically create phonetic transcriptions for words not yet in the lexicon. Additionally, for certain applications the lexicon needs to be created dynamically since the set of words is dynamically determined. An example of this latter category is where speech recognizer is used for accessing web pages (browsing the web by speech). The vocabulary for such applications is very specific and contains many unusual words (e.g. hyperlinks). It is therefore desired to automatically create a lexicon for such applications. Phonetic transcriptions are also required for other speech applications like speech synthesis.

Automatic transcription of a Japanese word to a phonetic representation (reading) is notoriously difficult. Japanese orthography is a mixture of three types of characters, namely kanji, hiragana, and katakana. A Japanese word can contain characters of each type within the word. Hiragana and katakana (collectively referred to as kana) are syllabaries and represent exactly how they should be read, i.e. for each of hiragana and katakana character there is a corresponding reading (phonetic transcription). So, a kana character does have a defined pronunciation. It does not have a defined meaning (the meaning also depends on other characters in the word, similar to alphabetic characters in Western languages). The two kana sets, hiragana and katakana, are essentially the same, but they have different shapes. Hiragana is mainly used for Japanese words, while katakana is mainly used for imported words. The kanji characters are based on the original Chinese Han characters. Unlike the kana characters, the kanji characters are ideograms, i.e. they stand for both a meaning and pronunciation. However, the pronunciation is not unambiguously defined for the character itself. Each kanji character normally has two classes of reading and each class usually contains more than one variation, making automatic determining of a reading difficult One class of readings of the kanji characters is the so-called on-readings (onyomi), which are related to their original Chinese readings. The other class contains the kun-readings (kunyomi) which are native Japanese readings. Because each kanji character can be read in many different ways, automatically determining a correct reading of a kanji word is very difficult. Both classes of readings (and the variation within the classes) can be unambiguously represented in hiragana. As such, once a reading has been determined for a kanji word (i.e. a word with at least one kanji character in it), the kanji characters can be converted to hiragana. Also, katakana characters can be converted to hiragana. Consequently, once a reading of a word has been determined the word and its reading can be represented using hiragana characters only. Similarly, a word can also be represented using katakana only. Therefore, automatic determining of a reading of a Japanese word is also desired for transcription of Japanese text corpora to hiragana (or katakana).

It is an object of the invention to provide a method and system for automatically determine a reading of a Japanese word.

To meet the object of the invention, the method of automatically determining a reading of a Japanese word includes:

receiving an input sting of at least one character representing the Japanese word;

choosing for each character of the Japanese word a corresponding reading, by:
for each character determining whether the character is a kanji hiragana, or katakana character;
for a hiragana or katakana character choosing the only one reading associated with the character, and
for a kanji character determining whether or not the immediately preceding character and/or the immediately succeeding character is also a kanji character;
and choosing for the kanji character an on-reading associated with the kanji character if the immediately preceding character and/or the immediately succeeding character in the word is also a kanji character, and choosing a kun-reading associated with the kanji character otherwise;

concatenating the corresponding readings of each character of the Japanese word; and

outputting the concatenated reading.

The inventor has realized that using a selection criterion based on whether or not a kanji character is isolated (has no neighboring kanji characters in the word) makes it possible to easily select between an on or kun-class of reading of a kanji character while achieving a significantly better result compared to random choice or a choice based on the most frequent reading of the kanji character.

As described in the dependent claim 2, for a kanji character that in the word is not immediately preceded or succeeded by a kanji character, the method includes choosing a most frequent one of a plurality of kun-readings associated with the kanji character. Some kanji characters may be associated with several different kun-readings. The most frequently occurring one is selected. The several options may all be stored in a memory, possibly with their relative frequency of occurrence (or sorted on frequency). In this way, the method may, optionally, enable a user to select a different reading. If this is not required, the method may include storing the most frequent kun-reading of each kanji character in a memory for use during the conversion of a Japanese word in a textual form to an acoustical form. Similarly, as described in the dependent claim 3, for a kanji character that in the word is immediately preceded or succeeded by at least one kanji character, the method includes choosing a most frequent one of a plurality of on-readings associated with the kanji character.

As described in a preferred embodiment of the dependent claim 4, the most frequent on-reading is selected by also considering the neighboring kanji character(s). For the group of two or more kanji characters the most frequent on-reading is chosen and applied to the characters of the group. In this way, the quality can be improved further than when the decision is made solely based on the frequency of reading of isolated characters.

As described in the dependent claim 5, each hiragana character is associated with one reading and for a hiragana character of the word the associated reading is chosen.

As described in the dependent claim 6, each katakana character is associated with a corresponding hiragana character; and for a katakana character of the word choosing the reading associated with the hiragana character corresponding to the katakana character.

To meet an object of the invention, a system for automatically determining a reading of a Japanese word includes:

an input for receiving an input string of at least one character representing the Japanese word;

a memory for storing:

for hiragana characters a respective associated reading;

for katakana characters a respective associated reading; and

for a kanji character a respective associated on-reading and a respective associated kun-reading;

a processor for determining for each character of the Japanese word a corresponding reading, by:
for each character determining whether the character is a kanji, hiragana, or katakana character;
for a hiragana or katakana character choosing the stored reading associated with the character; and
for a kanji character determining whether or not the immediately preceding character, and choosing for the kanji character the on-reading associated with the kanji character if the immediately preceding character and/or the immediately succeeding character in the word is also a kanji character, and choosing the kun-reading associated with the kanji character otherwise; and

for concatenating the corresponding readings of each character of the Japanese word; and

an output for outputting the concatenated reading.

These and other aspects of the invention are apparent from and will be elucidated with reference to the embodiments described hereinafter.

### BRIEF DESCRIPTION OF THE DRAWINGS

In the drawings:

FIG. 1 shows the elements of a typical speech recognizer;

FIG. 2 illustrates M-based word models;

FIG. 3 shows a table for storing the reading of a kana character;

FIG. 4 shows a table for storing the on-reading and kun-reading of a kanji character;

FIG. 5 shows a flow diagram of the method according to the invention;

FIG. 6 shows a flow diagram for determining kanji neighbors; and

FIG. 7 shows a block diagram of a system according to the invention

The method according to the invention can be used for several applications, including speech synthesis, transcription of Japanese text corpora to hiragana or katakana, and speech recognition The method is particularly useful for large vocabulary speech recognizers and/or voice control, where the vocabulary is not known in advance and changes regularly. A particular example of such an application is control of a web browser using speech. In such applications, the speech recognizer needs to have an acoustic transcription of each possible word/phrase that can be spoken by a user. Since the vocabulary is unknown in advance, the system has to generate the transcriptions automatically based on text items on the web page, such as links, that can be spoken by the user. So, the system has to be able to create an acoustic transcription of a displayed LINK. The method according to the invention provides rules for converting Japanese text (e.g. a link) to an acoustic representation. The method will be described in more detail for a large vocabulary speech recognizer.

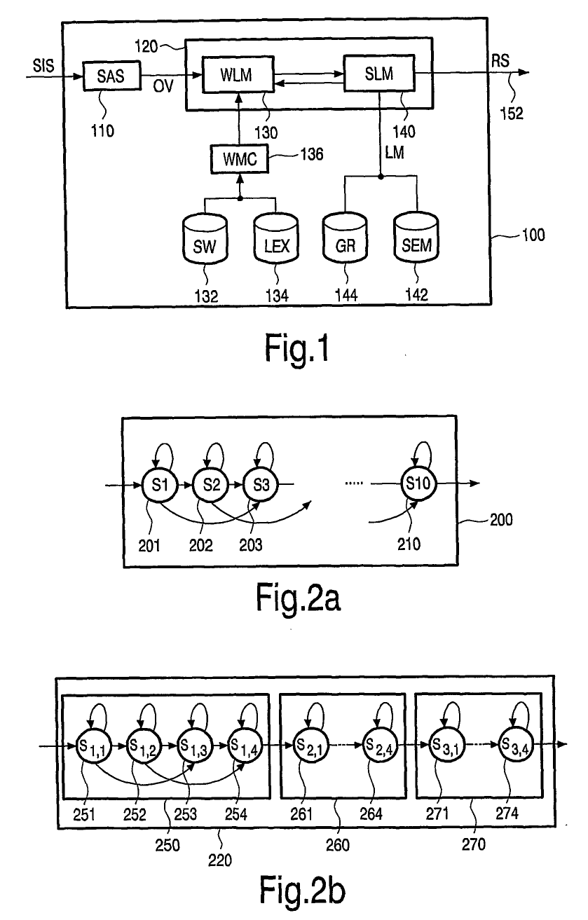

Speech recognition systems, such as large vocabulary continuous speech recognition systems, typically use a collection of recognition models to recognize an input pattern. For instance, an acoustic model and a vocabulary may be used to recognize words and a language model may be used to improve the basic recognition result FIG. 1 illustrates a typical structure of a large vocabulary continuous speech recognition system 100 [refer L. Rabiner, B H. Juang, “Fundamentals of speech recognition”, Prentice Hall 1993, pages 434 to 454]. The system 100 comprises a spectral analysis subsystem 110 and a unit matching subsystem 120. In the spectral analysis subsystem 110 the speech input signal (SIS) is spectrally and/or temporally analyzed to calculate a representative vector of features (observation vector, OV). Typically, the speech signal is digitized (e.g. sampled at a rate of 6.67 kHz.) and pre-processed, for instance by applying pre-emphasis. Consecutive samples are grouped (blocked) into frames, corresponding to, for instance, 32 msec. of speech signal. Successive frames partially overlap, for instance, 16 msec. Often the Linear Predictive Coding (LPC) spectral analysis method is used to calculate for each frame a representative vector of features (observation vector). The feature vector may, for instance, have 24, 32 or 63 components. The standard approach to large vocabulary continuous speech recognition is to assume a probabilistic model of speech production, whereby a specified word sequence W=W1w2w3 . . . wq produces a sequence of acoustic observation vectors Y=y1y2y3 . . . yT. The recognition error can be statistically minimized by determining the sequence of words w1w2w3 . . . wq which most probably caused the observed sequence of observation vectors y1y2y3 . . . yT (over time t=1, . . . , T), where the observation vectors are the outcome of the spectral analysis subsystem 110. This results in determining the maximum a posteriori probability:
max P(W|Y), for all possible word sequences W

By applying Bayes' theorem on conditional probabilities, P(M|Y) is given by:
P(W|Y)=P(Y|W).P(W)/P(Y)

Since P(Y) is independent of W, the most probable word sequence is given by:
arg max P(Y|W).P(W) for all possible word sequences W (1)

In the unit matching subsystem 120, an acoustic model provides the first term of equation (1). The acoustic model is used to estimate the probability P(Y|W) of a sequence of observation vectors Y for a given word sting W. For a large vocabulary system, this is usually performed by matching the observation vectors against an inventory of speech recognition units. A speech recognition unit is represented by a sequence of acoustic references. Various forms of speech recognition units may be used. As an example, a whole word or even a group of words may be represented by one speech recognition unit. A word model (WM) provides for each word of a given vocabulary a transcription in a sequence of acoustic references. In most small vocabulary speech recognition systems, a whole word is represented by a speech recognition unit, in which case a direct relationship exists between the word model and the speech recognition unit In other small vocabulary systems, for instance used for recognizing a relatively large number of words (e.g. several hundreds), or in large vocabulary systems, use can be made of linguistically based sub-word units, such as phones, diphones or syllables, as well as derivative units, such as fenenes and fenones. For such systems, a word model is given by a lexicon 134, describing the sequence of sub-word units relating to a word of the vocabulary, and the sub-word models 132, describing sequences of acoustic references of the involved speech recognition unit. A word model composer 136 composes the word model based on the subword model 132 and the lexicon 134.

FIG. 2A illustrates a word model 200 for a system based on whole-word speech recognition units, where the speech recognition unit of the shown word is modeled using a sequence of ten acoustic references (201 to 210). FIG. 2B illustrates a word model 220 for a system based on sub-word units, where the shown word is modeled by a sequence of Deime sub-word models (250, 260 and 270), each with a sequence of four acoustic references (251, 252, 253, 254; 261 to 264; 271 to 274). The word models shown in FIG. 2 are based on Hidden Markov Models (HMMs), which are widely used to stochastically model speech signals. Using this model, each recognition unit (word model or subword model) is typically characterized by an I whose parameters are estimated from a training set of data. For large vocabulary speech recognition systems usually a limited set of, for instance 40, sub-word units is used, since it would require a lot of training data to adequately train an HMM for larger units. An HMM state corresponds to an acoustic reference. Various techniques are known for modeling a reference, including discrete or continuous probability densities. Each sequence of acoustic references which relate to one specific utterance is also referred as an acoustic transcription of the utterance. It will be appreciated that if other recognition techniques than HNMs are used, details of the acoustic transcription will be different.

A word level matching system 130 of FIG. 1 matches the observation vectors against all sequences of speech recognition units and provides the likelihoods of a match between the vector and a sequence. If sub-word units are used, constraints can be placed on the matching by using the lexicon 134 to limit the possible sequence of sub-word units to sequences in the lexicon 134. This reduces the outcome to possible sequences of words.

Furthermore a sentence level matching system 140 may be used which, based on a language model (LM), places further constraints on the matching so that the paths investigated are those corresponding to word sequences which are proper sequences as specified by the language model. As such the language model provides the second term P(W) of equation (1). Combining the results of the acoustic model with those of the language model, results in an outcome of the unit matching subsystem 120 which is a recognized sentence (RS) 152. The language model used in pattern recognition may include syntactical and/or semantical constraints 142 of the language and the recognition task A language model based on syntactical constraints is usually referred to as a grammar 144. The grammar 144 used by the language model provides the probability of a word sequence W =w1w2w3 . . . wq, which in principle is given by:
P(W)=P(w1)P(w2|w1).P(w3|w1w2) . . . P(wq|w1w2w3 . . . wq).

Since in practice it is infeasible to reliably estimate the conditional word probabilities for all words and all sequence lengths in a given language, N-gram word models are widely used. In an N-gram model, the term P(wj|w1w2w3 . . .wj−1) is approximated by P(wj|wj−N+1. . . wj−1). In practice, bigrams or trigrams are used. In a trigram, the term P(wj|w1w2w3 . . . wj−1) is approximated by P(wj|wj-−2wj−1).

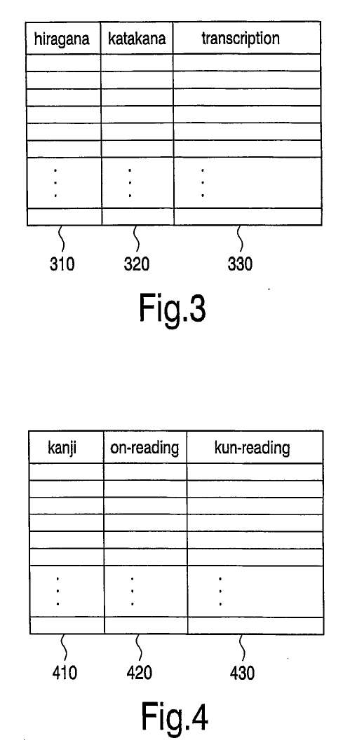

As described above, a word model (WM) provides for each word of a given vocabulary a transcription in a sequence of acoustic references. This is also required for Japanese words. Hiragana and katakana are syllabaries and represent exactly how they should be read, i.e. for each of hiragana and katakana character there is a corresponding reading (phonetic transcription). This means that a Japanese word written using only hiragana and/or katakana characters can be converted to a corresponding acoustic transcription by concatenating the acoustic transcriptions of the individual characters. FIG. 3 shows a table can be used for the conversion method. The table has a separate row for each hiragana character supported by the system Preferably, all hiragana characters are supported. In total there are 83 different hiragana characters, of which two are considered ancient and are not frequently used any more. In the exemplary table, column 310 identifies the hiragana character, for example in a digital form, using a one-byte representation. Any suitable sequence may be used. For example, any of the several standard coding tables that are available for hiragana, katakana, and kanji may be used. The most frequently used ones include Shift-JIS, New-JIS, EUC-JP, Unicode, and UTF-8. The tables differ in that different byte values are used to represent the same character. For example, Shift-JIS uses the hexadecimal value ‘82 A0’ for the big hiragana /a/, while EUC-JP uses ‘A4 A2’ for the same character. Each coding standard defines code values for hiragana, katakana, and kanji, as well as for other symbols, such as Roman alphabet and punctuation marks. In column 330, the corresponding acoustic transcription is stored for each of the hiragana characters. Any suitable acoustic representation may be used, for example using a phonetic representation. It is well-known how an acoustic representation for Japanese characters can be made and this will not be described in more detail here. In column 320 an identification of the corresponding katakana character is stored. Using this table, an acoustic transcription can be found for individual hiragana characters and katakana characters. Also, a katakana character can be converted to a hiragana character (or vice versa), (partly) enabling transcription of Japanese text corpora. It will be appreciated that instead of one acoustic representation stored in column 330, the system may include several acoustic representations, where each column with a different representation corresponds to a regional variation in pronunciation (also referred to as accent).

FIG. 4 shows a further table for use by the method. The table has a separate row for each kanji character supported by the system. Preferably, all kanji characters are supported, which are about 600o different characters. If so desired, the number of supported kanji characters may be limited, for example to the 500 or 1000 most used characters. A suitable subset is the “Joyo kanji” list, an official listing of 1,945 kanji characters published in 1981 by the Japanese Ministry of Education. The list comprises all the kanji one might expect to encounter in “everyday use”—on signs, in newspapers and so on. In the exemplary table, column 410 identifies the kanji character, for example in a digital form, using a two-byte representation. Any suitable sequence may be used. In column 420, a corresponding acoustic transcription is stored for each of the kanji characters in the form of a representation of the most frequent on-reading of the character, for example using a phonetic or other suitable representation. In column 430, a further corresponding acoustic transcription is stored for each of the kanji characters in the form of a representation of the most frequent kun-reading of the character. It is well-known to create acoustic representations of the different classes of reading of kanji characters and the choices within each class are well-known and this will not be described in more detail here. It will be appreciated that instead of one acoustic representation stored in each of the columns 420 and 430, the system may include several acoustic representations for each of the readings, where each sub-column with a different representation corresponds to a regional variation in pronunciation (also referred to as accent). The table shown in FIG. 4, in principle, enables finding an acoustic transcription for individual kanji characters. Below, more details will be given on determining a preferred acoustic transcription. Since hiragana (and also katakana) can be used as an acoustic representation (“reading”) of a kanji character, columns 420 and 430 may also include one or more hiragana characters that represent the acoustic transcription (or if so desired, the columns may include katakana characters). In this way, the table can also be used for converting individual kanji characters to hiragana (and/or kataki) characters. As such, the combination of tables shown in FIGS. 3 and 4, enable transcription of Japanese text corpora to hiragana (and/or katakana). For applications, like speech recognition and speech synthesis, it is usually preferred to also have access to an acoustic representation other than hiragana or katakana). For this purpose, column 330 of FIG. 3 and columns 420 and 430 of FIG. 4 can be used. If the purpose is solely to perform a transcription of Japanese text corpora, column 330 is not required Instead in columns 420 and 430 the hiragana (or katakana) transcription can be given as the on-reading and kun-reading, respectively.

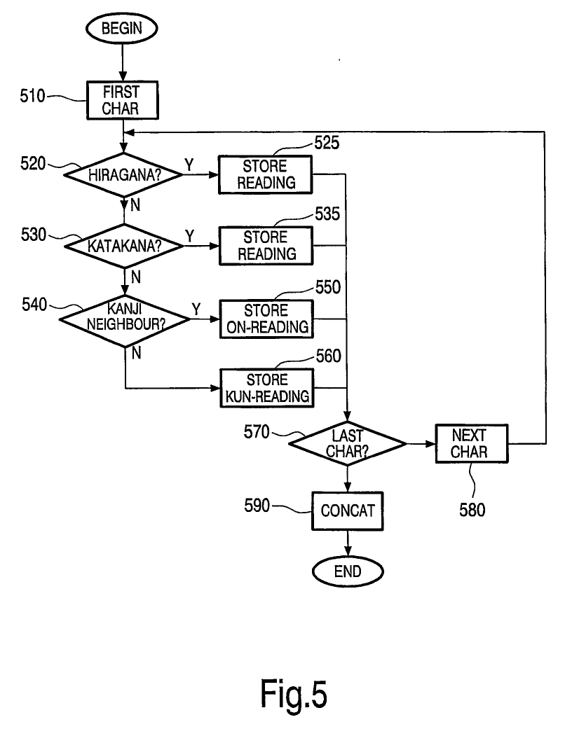

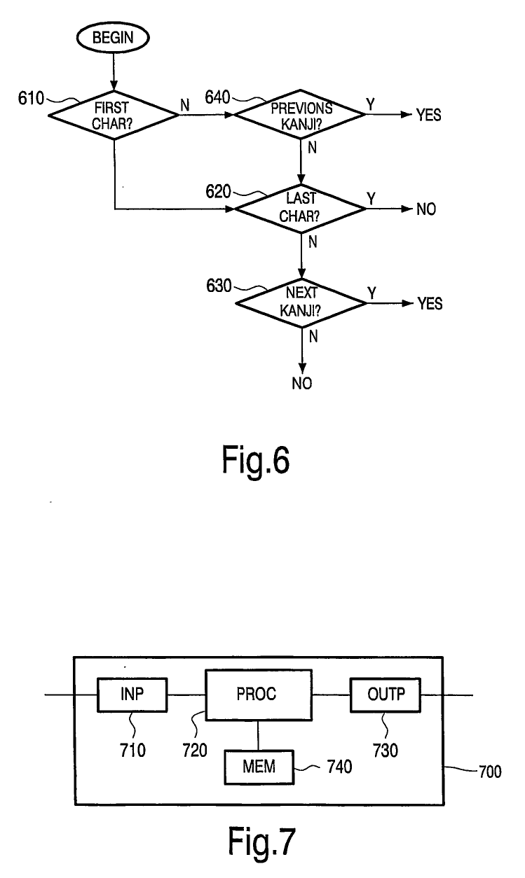

FIG. 5 shows a flow-diagram of the preferred method for determining the reading of a Japanese word. In principle, characters are converted separately. Preferably, conversion starts with the first character as is shown in step 510. In steps 520 and 530 a test is done to determine whether the character to be converted is a hiragana or katakana character, respectively. In step 525, for a hiragana character the corresponding reading is loaded from column 330 of the table of FIG. 3 and stored in a memory. The row in the table is selected under control of the representation of the character being converted (preferably, the representation of the character is the row number given in column 310 or can be easily converted to the row number). Similarly, in step 535, for a katakana character the corresponding reading is loaded from column 330 of the table of FIG. 3 and stored in a memory. As described for the conversion of the hiragana character, the row in the table is selected under control of the representation of the character being converted (preferably, the representation of the character is the row number given in column 320 or can be easily converted to the row number). If the character is not a hiragana character and not a katakana character, it is assumed to be a kanji character. If so desired, a separate test may be done to determine whether or not it is a kanji character (e.g. it has a coding according to a chosen kanji table). In step 540 a test is done to determine whether the kanji character has at least one neighboring character in the word that is also a kanji character. Any person skilled in the art will be able to perform this test. One way of testing it is shown in FIG. 6. In step 610, it is tested whether or not the character is the first character of a word. If so, in step 620 it is tested whether the character is the only character of the word (which is the same as testing whether the character is the last character of the word). If so, the outcome is: NO (no neighboring kanji characters). If yes, in step 630 it is tested whether the immediately successive character in the word is a kanji character. If so, the outcome is YES. If not the outcome is NO. The other option of step 610 is that the character being tested is not the first character of the word. In step 640, it is the tested whether the immediately preceding character is a kanji character. If so, the outcome is YES. If not, in step 620 a test is performed to determine if the character being tested is the last character of the word. If so, the outcome is NO. If not the test of step 630 is performed to see if the immediately successive character in the word a kanji character. Returning now to step 540 of FIG. 5, if the kanji character has at least one neighboring kanji character in step 550 an on-reading is chosen, otherwise in step 560 a kun-reading is chosen. The corresponding reading can be loaded from column 420 or 430, respectively, of the table of FIG. 4 and stored in a memory. In step 570, a test is performed to see if all characters of the word have been processed. If not, in step 580 the next character is taken and processing continues with this character at step 520. If so, in step 590 all stored readings of the successive characters are concatenated and give the total reading of the word.

It is not relevant for the method in which sequence the different types of characters are converted. In FIG. 5 the first test is for hiragana, then for katakana, followed by kanji. But this may be done in any order. In fact, the hiragana and katakana characters may be coded using distinct ranges of code numbers. If so, the test 520 and 530 can be reduced to one by suitably arranging table 3, so that one code number can be used for selecting a hiragana or katakana character.

In the preferred embodiment, columns 420 and 430 store the most frequent readings. In principle, also less frequent readings may be stored, although using the most frequent reading in general gives best results. In the flow shown in FIG. 5 and using the table of FIG. 4, once the class of reading has been determined based on the number of neighboring kanji characters, the reading is chosen solely based on the kanji character itself. Particularly when there is more than one successive kanji character (and thus the on-class of reading has been selected), it is preferred to base the decision on the actual reading also on at least one of the neighboring kanji characters. Preferably, the group of all neighboring kanji characters is taken together and the most frequent reading for the entire group is chosen. This reading may then be split up in the readings of the individual characters (and later on concatenated in step 590. Advantageously, the entire group of successive kanji characters is processed in one operation (without a need for splitting and re-concatenation). For determining the reading of a group of more than one kanji character, a new table may be used (or table 4 may be modified), so that in the first column also pairs, triples, etc. of kanji characters can be represented, and in the second column the on-reading of the entire group is given.

Experimental Results

The proposed method has been tested on three sets of kanji words. These sets are collected from databases of different domains of interest. Some statistics about these sets are given in the following table. For this test the most frequent reading was chosen for individual kanji characters.

| Test Set | A | B | C |
|---|---|---|---|
| Number of Kanji words in the test set | 336 | 1779 | 762 |
| Total number of hiragana characters in the | 1304 | 7170 | 3595 |
| readings of the words in the test set | | | |

The performance of the proposed method is measured in terms of the hiragana character error rate (HCER), which is defined as

$$HCER = \frac{\# insertions + \# deletions + \# substititions}{Total \# hiragana characters in readings}$$

To show the efficiency of the method, a comparison is made with the following two other methods:
Method 1: Randomly choose a reading for each character in the kanji word. Then use the concatenation as the reading for the word.
Method 2: Choose the most frequent reading for each character in the kanji word, without regarding whether it is on-reading or kun-reading. Then use the concatenation as the reading for the word.

The results are indicated in the following table, which shows that the method according to the invention out performs the other two methods.

| Test Set | A | B | C |
|---|---|---|---|
| Method 1 | 52.0% | 57.6% | 62.0% |
| Method 2 | 43.6% | 42.9% | 33.3% |
| Method according to the invention | 20.3% | 21.3% | 17.8% |

FIG. 7 shows a block diagram of a system 700 for automatically determining a reading of a Japanese word. The system 700 includes an input 710 for receiving an input string of at least one character representing the Japanese word. A memory 740 is used for storing for hiragana characters a respective associated reading; for katakana characters a respective associated reading; for a kanji character a respective associated on-reading and a respective associated kun-reading. The memory may, for example, store the tables shown in FIGS. 3 and 4. A processor 720 is used for determining for each character of the Japanese word a corresponding reading. The determining is done according to the method described above. To this end, the processor 720 can be loaded with software functions for:

for each character determining whether the character is a kanji, hiragana, or katakana character;
for a hiragana or katakana character choosing the stored reading associated with the character; and
for a kanji character determining whether or not the immediately preceding character and/or the immediately succeeding character is also a kanji character, and choosing for the kanji character the on-reading associated with the kanji character if the immediately preceding character and/or the immediately succeeding character in the word is also a kanji character, and choosing the kun-reading associated with the kanji character otherwise; and

Additionally, the processor can be loaded with a software function for concatenating the corresponding readings of each character of the Japanese word. The system 700 also includes an output 720 for outputting the concatenated reading. The processor 720 may also be used for various applications for which the outcome of the method can be used, such as speech recognition.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim The words “comprising” and “including” do not exclude the presence of other elements or steps than those listed in a claim. The invention can be implemented by means of hardware comprising several distinct elements, and by means of a suitably programmed computer. Where the system/device/apparatus claims enumerate several means, several of these means can be embodied by one and the same item of hardware. The computer program product may be stored/distributed on a suitable medium, such as optical storage, but may also be distributed in other forms, such as being distributed via the Internet or wireless telecommunication systems.

1. A method of automatically determining a reading of a Japanese word; the method including:
receiving an input string of at least one character representing the Japanese word;
choosing for each character of the Japanese word a corresponding reading, by:
for each character determining whether the character is a kanji hiragana, or katakana character;
for a hiragana or katakana character choosing the only one reading associated with the character; and
for a kanji character determining whether or not the immediately preceding character and/or the immediately succeeding character is also a kanji character; and choosing for the kanji character an on-reading associated with the kanji character if the immediately preceding character and/or the immediately succeeding character in the word is also a kanji character, and choosing a kun-reading associated with the kanji character otherwise;
concatenating the corresponding readings of each character of the Japanese word; and
outputting the concatenated reading.

2. A method as claimed in claim 1, wherein for a kanji character that in the word is not immediately preceded or succeeded by a kanji character, the method includes choosing a most frequent one of a plurality of kun-readings associated with the kanji character.

3. A method as claimed in claim 1, wherein for a kanji character that in the word is immediately preceded or succeeded by at least one kanji character, the method includes choosing a most frequent one of a plurality of on-readings associated with the kanji character.

4. A method as claimed in claim 3, wherein the step of choosing a most frequent one of a plurality of on-readings associated with the kanji character includes selecting a group of a plurality of sequential kanji characters in the word, including the kanji character being converted, and choosing a most frequent one of a plurality of on-readings associated with the group of kanji characters.

5. A method as claimed in claim 1, wherein each hiragana character is associated with one reading; and the method includes for a hiragana character of the word choosing the associated reading.

6. A method as claimed in claim 5, wherein each katakana character is associated with a corresponding hiragana character; and the method includes for a hiragana character of the word choosing the reading associated with the hiragana character corresponding to the katakana character.

7. A computer program product operative to cause a processor to perform the method as claimed in claim 1.

8. A system for automatically determining a reading of a Japanese word includes:
an input for receiving an input string of at least one character representing the Japanese word;
a memory for storing;
for hiragana characters a respective associated reading;
for katakana characters a respective associated reading; and
for a kanji character a respective associated on-reading and a respective associated kun-reading;
a processor for determining for each character of the Japanese word a corresponding reading, by:
for each character determining whether the character is a kanji, hiragana, or katakana character;
for a hiragana or katakana character choosing the stored reading associated with the character; and
for a kanji character determining whether or not the immediately preceding character and/or the immediately succeeding character is also a kanji character; and choosing for the kanji character the on-reading associated with the kanji character if the immediately preceding character and/or the immediately succeeding character in the word is also a kanji character, and choosing the kun-reading associated with the kanji character otherwise; and
for concatenating the corresponding readings of each character of the Japanese word; and
an output for outputting the concatenated reading.
